(19) United States
(12) Patent Application Publication
(10) Pub. No.: US 2015/0358540 A1
(43) Pub. Date: Dec. 10, 2015

(54) METHOD AND DEVICE FOR GENERATING A SURROUND-VIEW IMAGE OF THE SURROUNDINGS OF A VEHICLE, METHOD FOR PROVIDING AT LEAST ONE DRIVER-ASSISTANCE FUNCTION FOR A VEHICLE, SURROUND-VIEW SYSTEM FOR A VEHICLE

(71) Applicant: ROBERT BOSCH GMBH, Stuttgart (DE)

(72) Inventors: Pascal KANTER, Peissenberg (DE); Henning Voetz, Stuttgart (DE)

(21) Appl. No.: 14/760,751

(22) PCT Filed: Jan. 14, 2014
(86) PCT No.: PCT/EP2014/050597

§ 371 Date: Jul. 14, 2015

(30) Foreign Application Priority Data
Jan. 14, 2013 (DE) 10 2013 200 427.3

(51) Int. Cl. H04N 5/232; H04N 5/247; B60R 1/00; H04N 7/18; H04N 5/33; H04N 5/225; G06T 5/50

(52) U.S. Cl. CPC H04N 5/23238; H04N 5/2256; H04N 5/247; G06T 5/50; H04N 7/181; H04N 5/2253; H04N 5/33; B60R 1/00; G06T 2207/20212; G06T 2207/30264; G06T 2207/10048; G06T 2207/30261; G06T 2207/10016; B60R 2300/802; B60R 2300/105; B60R 2300/303

(57) ABSTRACT

A method for generating a surround-view image of a vehicle 's surroundings, having a first vehicle camera for photographing a first partial area of the surroundings and at least one second vehicle camera for photographing a second partial area of the surroundings differing at least in part from the first partial area, including illuminating the surroundings with at least two illumination devices. Using at least one first illumination device, the first partial area of the surroundings is illuminated by electromagnetic radiation in the visible and/or infrared wavelength range. Using at least one second illumination device, the second partial area of the surroundings is illuminated by electromagnetic radiation at least in the infrared wavelength range. The method also includes reading in camera image data, so as by combining the image data, to generate the surround-view image of the surroundings, the image data representing photos of partial areas of the illuminated surroundings.

### FIELD OF THE INVENTION

The present invention relates to a method for generating a surround-view image of the surroundings of a vehicle, a method for providing at least one driver-assistance function for a vehicle using a surround-view image of the vehicle surroundings, a device for generating a surround-view image of the surroundings of a vehicle, a surround-view system for a vehicle, as well as a corresponding computer-program product.

### BACKGROUND INFORMATION

Driver-assistance systems exist for assisting a driver in guiding a vehicle when parking. One exemplary system is a surround-view system which, with the aid of several cameras, suggests to the driver a view of his vehicle from above, so that the driver is able to move his vehicle in a virtual environment. In addition, the German Patent 102 26 278 A1 discusses a backup aid for vehicles.

### SUMMARY OF THE INVENTION

Against this background, an improved method for generating a surround-view image of the surroundings of a vehicle, an improved method for providing at least one driver-assistance function for a vehicle using a surround-view image of the vehicle surroundings, an improved device for generating a surround-view image of the surroundings of a vehicle, an improved surround-view system for a vehicle and an improved computer-program product according to the description herein are presented. Advantageous refinements are yielded from the respective further descriptions herein and the following description.

An especially advantageous method for generating a surround-view image of the surroundings of a vehicle, where the vehicle has a first vehicle camera for photographing a first partial area of the vehicle surroundings and at least one second vehicle camera for photographing a second partial area of the vehicle surroundings differing at least in part from the first partial area of the surroundings, has the following steps:

Effectuating the illumination of the vehicle surroundings with the aid of at least two illumination devices, where using at least one first illumination device, the first partial area of the vehicle surroundings is illuminated by electromagnetic radiation in the visible wavelength range and/or in the infrared wavelength range, and using at least one second illumination device, the second partial area of the vehicle surroundings is illuminated by electromagnetic radiation at least in the infrared wavelength range; and

Reading in image data from the vehicle cameras, the image data representing photos of the partial areas of the illuminated vehicle surroundings, so as by combining the image data, to generate the surround-view image of the surroundings of the vehicle.

The vehicle may be a motor vehicle, especially a road-going motor vehicle such as an automobile, a truck or other commercial vehicle. The surround-view image may represent an overall image of the vehicle surroundings made up of individual images from individual vehicle cameras. The surround-view image may represent the vehicle from a virtual bird's-eye view. The vehicle surroundings may possess a close-up area of the surroundings of the vehicle adjacent to the vehicle. The partial areas of the, vehicle surroundings may overlap in part or be separate from each other, that is, have no sections in common. The first vehicle camera may be configured to pick up electromagnetic radiation in the visible wavelength range and possibly also electromagnetic radiation in the infrared wavelength range. The at least one second vehicle camera may be configured to pick up at least electromagnetic radiation in the infrared wavelength range. The vehicle cameras may be configured to generate or provide the image data. In addition, at least one further vehicle camera may be provided to illuminate at least one further partial area of the vehicle surroundings. In the step of reading-in, the image data may be read in from an interface to the vehicle cameras. In the step of effectuating the illumination, at least one driving signal may be output to an interface to the illumination devices in order to bring about the illumination.

The first illumination device may be configured to radiate electromagnetic radiation in the visible wavelength range, i.e., electromagnetic radiation in a spectral range or wavelength range visible to the human eye. The first illumination device may also be configured to radiate electromagnetic radiation in the infrared region or infrared range. Alternatively, the first illumination device may be configured to radiate electromagnetic radiation in the visible range, that is, electromagnetic radiation in a spectral range or wavelength range visible to the human eye, as well as electromagnetic radiation in the infrared region or infrared range. The second illumination device may be configured to radiate electromagnetic radiation in the infrared region or infrared range. Alternatively, the second illumination device may be configured to radiate electromagnetic radiation in the infrared range, as well as electromagnetic radiation in the visible range. The visible range or spectral range of the electromagnetic radiation may include wavelengths of 380 nanometers to 780 nanometers. Electromagnetic radiation in the visible range relates to light. The infrared range of the electromagnetic radiation may include wavelengths of 780 nanometers to 1 millimeter.

An especially advantageous method for providing at least one driver-assistance function for a vehicle using a surround-view image of the surroundings of the vehicle, where the vehicle has a first vehicle camera for photographing a first partial area of the vehicle surroundings and at least one second vehicle camera for photographing a second partial area of the vehicle surroundings differing at least in part from the first partial area of the surroundings, has the following steps:

Executing the steps of a version of the method indicated above, in order to generate the surround-view image of the surroundings of the vehicle; and

Evaluating the surround-view image generated, in order to provide the at least one driver-assistance function.

The method for providing at least one driver-assistance function may be carried out advantageously in conjunction with a version of the method indicated above for generating a surround-view image. In this context, prior to the step of evaluating the surround-view image, the method for providing may also have the steps of a version of the method indicated above for generating the surround-view image.

An especially advantageous device for generating a surround-view image of the surroundings of a vehicle, where the vehicle has a first vehicle camera for photographing a first partial area of the vehicle surroundings and at least one second vehicle camera for photographing a second partial area of the vehicle surroundings differing at least in part from the first partial area of the surroundings, has the following features:

A unit to effectuate illumination of the vehicle surroundings with the aid of at least two illumination devices, where using at least one first illumination device, the first partial area of the vehicle surroundings is illuminated by electromagnetic radiation in the visible range or in the visible range and in the infrared range, and using at least one second illumination device, the second partial area of the vehicle surroundings is illuminated by electromagnetic radiation in the infrared range or in the infrared range and in the visible range; and

A unit for reading in image data from the vehicle cameras, the image data representing photos of the partial areas of the illuminated vehicle surroundings, so as by combining the image data, to generate the surround-view image of the surroundings of the vehicle.

The device for generating may be part of a vehicle camera or part of an apparatus provided separately from the vehicle cameras. The device may also be part of a driver-assistance device. A device in the present case may be understood to be an electrical unit or control unit that outputs driving signals to bring about the illumination and processes image data in response to that. The device may have an interface which may be implemented in hardware and/or software. In the case of a hardware implementation, the interfaces may be part of what is termed a system ASIC, for example, that includes a wide variety of functions of the device. However, it is also possible that the interfaces are separate integrated circuits or are made up at least partially of discrete components. In the case of a software implementation, the interfaces may be software modules which, for example, are available in a microcontroller in addition to other software modules.

A device for generating a surround-view image of the surroundings of a vehicle is configured to carry out or implement the steps of a method indicated above for the generating. In particular, the device may have units which are configured to carry out one step each of a method indicated above for the generating.

A device for providing at least one driver-assistance function for a vehicle using a surround-view image of the vehicle surroundings is configured to carry out or implement the steps of a method indicated above for the providing. In particular, the device may have units which are configured to carry out one step each of a method indicated above for the providing.

An especially advantageous surround-view system for a vehicle has the following features:

A first vehicle camera for photographing a first partial area of a vehicle surroundings and a second vehicle camera for photographing a second partial area of the vehicle surroundings differing at least in part from the first partial area of the surroundings;

At least one first illumination device for illuminating the first partial area of the vehicle surroundings by electromagnetic radiation in the visible range or in the visible range and in the infrared range, and at least one second illumination device for illuminating the second partial area of the vehicle surroundings by electromagnetic radiation in the infrared range or in the infrared range and in the visible range; and

A version of the device indicated above for generating a surround-view image of the surroundings of a vehicle.

A version of the device indicated above for the generating may be employed or used advantageously in conjunction with the surround-view system. A version of the method indicated above for the generating and/or a version of the method indicated above for the providing may also be carried out advantageously in conjunction with the surround-view system in order to generate the surround-view image and to provide at least one driver-assistance function, respectively.

Also advantageous is a computer-program product having program code which is stored in a machine-readable medium such as a semiconductor memory, a hard-disk storage or an optical memory, and is used to implement a method indicated above when the program is executed on a computer or in a device.

According to specific embodiments of the present invention, a surround-view system of a vehicle may be equipped especially with an additional active infrared illumination, e.g., in the form of at least one short-range infrared headlight. In this case, in particular, an area of a vehicle surroundings in the reverse direction of travel may be illuminated by infrared radiation. Other illumination directions, e.g., illumination to the side from illumination sources in exterior mirrors, may also be provided as an option. Thus, an existing surround-view system may be expanded by at least one infrared headlight/taillight. Such infrared headlights/taillights may be provided at least for an illumination direction in the reverse direction of travel, or optionally for several illumination directions.

Advantageously, according to specific embodiments of the present invention, camera-based surround-view systems may be improved especially by an active infrared illumination, e.g., in the near infrared (NIR). In particular, a representation of surround-view images in situations having low or highly varied illumination may be improved. As a rule, a front area of a vehicle surroundings is illuminated by headlights. In particular, a rear part of the vehicle surroundings behind a vehicle tail may be very dark at poorly lit locations of the vehicle, e.g., in the rural area, but may be illuminated advantageously with the aid of infrared illumination according to specific embodiments of the present invention. Thus, surround-view images of well-illuminated vehicle surroundings may be generated. A further advantage lies in the fact that at least one partial area of the vehicle surroundings is illuminated with electromagnetic radiation in the infrared range, thus, in a spectrum which is not perceptible to the human eye.

Blinding of other road users may thus be avoided, but the vehicle surroundings are nevertheless well-illuminated. This is also able to improve availability of functions based on surround-view images, that is, to permit or make such functions more reliable. Consequently, a surround-view system may be provided having higher availability and quality. Thus, in the area of application of the surround-view range, e.g., in the full speed range, the surroundings of the vehicle are able to be illuminated as well as possible so that, for example, lane, road, street or highway markings even next to and behind the vehicle may be detected well by a surround-view system, without blinding other road users. Existing systems or system components, especially cameras and existing illumination devices, may be utilized advantageously, as well.

According to one specific embodiment of the method for generating, in the step of effectuating the illumination, the electromagnetic radiation is radiated in the infrared range with a uniform spatial radiation characteristic. The uniform spatial radiation characteristic may feature a homogeneous luminance or light distribution or radiation of electromagnetic radiation in the infrared range by an illumination device. Such a specific embodiment offers the advantage that the vehicle surroundings may be illuminated as uniformly as possible.

Also in the step of effectuating the illumination, the electromagnetic radiation in the near infrared is radiated as the electromagnetic radiation in the infrared range. In this case, the at least one second vehicle camera may be made sensitive for the near infrared range. This may be realized inexpensively especially in the realm of surround-view images, because as a rule, close-range cameras used as vehicle cameras for surround-view images are not installed behind a window, e.g., the windshield, which is generally equipped with an infrared filter for heat insulation. Such a specific embodiment offers the advantage that the near infrared technology is suitable in the vehicle sector for night-vision applications and for monitoring areas such as the vehicle surroundings. An active illumination in the near infrared may be used advantageously here to also permit recognition of “cold” objects.

According to one specific embodiment of the method for the providing, in the evaluation step, the surround-view image generated may be evaluated with regard to areas having obstacles and freely negotiable areas in the vehicle surroundings, in order to make a parking-assistance function and/or a collision-warning function available. Thus, in the evaluation step, the surround-view image generated may be analyzed in order to detect image areas in which there are obstacles in the vehicle surroundings, and image areas in which there are freely negotiable areas in the vehicle surroundings. In addition, a step of outputting the surround-view image generated and/or the evaluated surround-view image to an interface to a display device and/or to a driver-assistance device may be provided. Such a specific embodiment offers the advantage of thus being able to lend higher availability and quality to a driver-assistance system. This holds true not only for representative assistance systems, but also for a functionality of functions such as parking assistance or warning functions. In particular, an expansion with infrared light sources and infrared sensors is able to increase safety, comfort and reliability of functions based on surround-view images to the benefit of the customer. Further practical applications based on the surround-view images generated may also be realized, for example, detection of passers-by and the like.

According to one specific embodiment of the surround-view system, the first vehicle camera may be positioned to photograph a partial area of the surroundings in the forward direction of travel of the vehicle as the first partial area of the vehicle surroundings. The second vehicle camera may also be positioned to photograph a partial area of the surroundings in the reverse direction of travel of the vehicle as the second partial area of the vehicle surroundings. Moreover, the at least one first illumination device may feature a headlight of the vehicle or be disposed in the area of a headlight of the vehicle. In addition, the at least one second illumination device may be situated in the area of a taillight of the vehicle. Thus, the first vehicle camera may be a front camera and the second vehicle camera may be a rear camera.

At least the second vehicle camera is sensitive to infrared radiation, that is, is configured to pick up electromagnetic radiation in the infrared range. The at least one first illumination device may be one of the headlights of the vehicle, or the at least one first illumination device may be an infrared light source, e.g., an infrared light-emitting diode or infrared LED, located in the area of a headlight. The at least one first illumination device may be integrated into a headlight module. In particular, two first illumination devices may be provided, one per headlight or vehicle side. The at least one second illumination device may be an infrared light source, e.g., an infrared light-emitting diode or infrared LED, located in the area of a taillight. The at least one second illumination device may be integrated into a taillight module. In particular, two second illumination devices may be provided, one per taillight or vehicle side. Such a specific embodiment offers the advantage of permitting good illumination and coverage of the vehicle surroundings with the aid of vehicle cameras and illumination devices, with little effort. Moreover, in the case of the surround-view system, optionally, illumination with the aid of the headlights of the vehicle may be utilized, as well.

A first vehicle side camera may also be provided on a first exterior mirror of the vehicle in order to photograph a first sideward partial area of the vehicle surroundings between the first partial area and the second partial area of the surroundings. Furthermore, a second vehicle side camera may be provided on a second exterior mirror of the vehicle in order to photograph a second sideward partial area of the vehicle surroundings, differing from the first sideward partial area of the surroundings, between the first partial area and the second partial area of the surroundings. In addition, a first side illumination device may be provided at the first exterior mirror for photographing the first sideward partial area of the surroundings with the aid of electromagnetic radiation in the infrared range. Moreover, a second side illumination device may be provided at the second exterior mirror for photographing the second sideward partial area of the surroundings with the aid of electromagnetic radiation in the infrared range. Such a specific embodiment offers the advantage that areas of the vehicle surroundings to the side next to the vehicle are also able to be illuminated and covered reliably in order to improve the surround-view image.

In particular, one vehicle camera may thus be placed in each exterior mirror, as well as one vehicle camera in the front and one vehicle camera at the rear of the vehicle. For example, in a further specific embodiment of the present invention, the front lights and taillights as well as flasher lights in the exterior mirrors or side mirrors are equipped with near infrared light-emitting diodes or NIR-LEDs which, for example, are configured to illuminate the vehicle surroundings, if applicable, continuously. Other mounting positions for the illumination devices are also conceivable, so long as the illumination devices reliably illuminate the coverage areas of the vehicle cameras. In addition, an auxiliary lighting may be given the ability to be switched on manually or automatically with the activation of functions that are based on the surround-view system.

The present invention is explained in greater detail by way of example with reference to the attached drawings.

In the following description of exemplary embodiments of the present invention, the same or similar reference numerals are used for the similarly functioning elements shown in the various figures, a repeated description of these elements being omitted.

### BRIEF DESCRIPTION OF THE DRAWINGS

FIG. 1 shows a schematic representation of a vehicle having a surround-view system according to one exemplary embodiment of the present invention.

FIGS. 2 and 3 show flowcharts of methods according to exemplary embodiments of the present invention.

### DETAILED DESCRIPTION

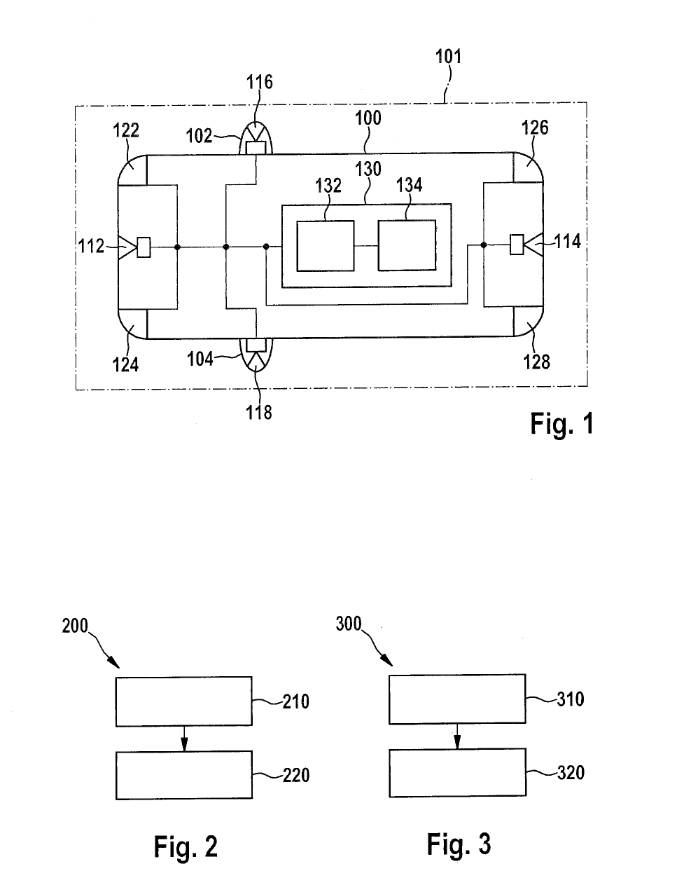

FIG. 1 shows a schematic representation of a vehicle 100 having a surround-view system according to one exemplary embodiment of the present invention. Shown are vehicle 100, a vehicle surroundings 101, a first exterior mirror 102, a second exterior mirror 104, a first vehicle camera 112, i.e., a front camera, a second vehicle camera 114, i.e., a rear camera, a first side camera 116, a second side camera 118, a first front illumination device 122, a second front illumination device 124, a first rear illumination device 126, a second rear illumination device 128, a generating device 130, an illumination-effectuating unit 132 and a read-in unit 134. Vehicle 100 is shown in vehicle surroundings 101.

The surround-view system is located in vehicle 100. The surround-view system has first vehicle camera 112, second vehicle camera 114, first side camera 116, second side camera 118, first front illumination device 122, second front illumination device 124, first rear illumination device 126, second rear illumination device 128, generating device 130, illumination-effectuating unit 132 and read-in unit 134. Generating device 130 features illumination-effectuating unit 132 and read-in unit 134. According to the exemplary embodiment of the present invention shown in FIG. 1, a number of cameras and illumination devices of the surround-view system is merely by way of example, and in other exemplary embodiments of the present invention, may differ from the number shown here, depending on the practical application.

First vehicle camera 112, second vehicle camera 114, first side camera 116, second side camera 118, first front illumination device 122, second front illumination device 124, first rear illumination device 126 and second rear illumination device 128 are connected to generating device 130 by at least one communication interface, e.g., electric lines, a wireless link or the like.

First vehicle camera 112 is located in a front area of vehicle 100. First vehicle camera 112 is configured to photograph a first partial area of vehicle surroundings 101 in the forward direction of travel of vehicle 100. First vehicle camera 112 is also configured to provide image data, which represent a photo of the first partial area of the surroundings, to generating device 130.

Second vehicle camera 114 is located in a rear area of vehicle 100. Second vehicle camera 114 is configured to photograph a second partial area of vehicle surroundings 101 in the reverse direction of travel of vehicle 100. Second vehicle camera 114 is also configured to provide image data, which represent a photo of the second partial area of the surroundings, to generating device 130.

First side camera 116 is located on first exterior mirror 102 of vehicle 100. First side camera 116 is configured to photograph a third partial area of vehicle surroundings 101 in a first sideward direction of vehicle 100. First side camera 116 is also configured to provide image data, which represent a photo of the third partial area of the surroundings, to generating device 130.

Second side camera 118 is located on second exterior mirror 104 of vehicle 100. Second side camera 118 is configured to photograph a fourth partial area of vehicle surroundings 101 in a second sideward direction of vehicle 100. Second side camera 118 is also configured to provide image data, which represent a photo of the fourth partial area of the surroundings, to generating device 130.

By way of example, first front illumination device 122 is integrated in a first headlight of vehicle 100. For example, first front illumination device 122 is a near infrared light-emitting diode, which is configured to radiate electromagnetic radiation in the near infrared range. First front illumination device 122 is configured to illuminate the first partial area of the surroundings.

By way of example, second front illumination device 124 is integrated in a second headlight of vehicle 100. For example, second front illumination device 124 is a near infrared light-emitting diode, which is configured to radiate electromagnetic radiation in the near infrared range. Second front illumination device 124 is configured to illuminate the first partial area of the surroundings.

By way of example, first rear illumination device 126 is integrated in a first taillight of vehicle 100. For example, first rear illumination device 126 is a near infrared light-emitting diode, which is configured to radiate electromagnetic radiation in the near infrared range. First rear illumination device 126 is configured to illuminate the second partial area of the surroundings.

By way of example, second rear illumination device 128 is integrated in a second taillight of vehicle 100. For example, second rear illumination device 128 is a near infrared light-emitting diode, which is configured to radiate electromagnetic radiation in the near infrared range. Second rear illumination device 128 is configured to illuminate the second partial area of the surroundings.

Although not shown in FIG. 1, the surround-view system has a first side illumination device and a second side illumination device. The first side illumination device and the second side illumination device are connected to generating device 130 by at least one communication interface, e.g., electric lines, a wireless link or the like.

The first side illumination device is located at first exterior mirror 102 of vehicle 100. Thus, the first side illumination device is situated adjacent to first side camera 116. For example, the first side illumination device is a near infrared light-emitting diode, which is configured to radiate electromagnetic radiation in the near infrared range. The first side illumination device is configured to illuminate the third partial area of the surroundings.

The second side illumination device is located at second exterior mirror 104 of vehicle 100. Thus, the second side illumination device is situated adjacent to second side camera 118. For example, the second side illumination device is a near infrared light-emitting diode, which is configured to radiate electromagnetic radiation in the near infrared range.

The second side illumination device is configured to illuminate the fourth partial area of the surroundings.

Generating device 130 is provided to generate a surround-view image of surroundings 101 of vehicle 100. The surround-view image represents an image of vehicle surroundings 101, that is, an image of the first partial area, the second partial area, the third partial area and the fourth partial area of surroundings 101 of vehicle 100. Here, the first partial area, the second partial area, the third partial area and the fourth partial area of vehicle surroundings 101 represent at least a major part of surroundings 101 of vehicle 100. In this connection, vehicle surroundings 101 extend from vehicle 100 into a definable distance from vehicle 100.

Illumination-effectuating unit 132 of generating device 130 is configured to bring about illumination of vehicle surroundings 101 with the aid of illumination devices 122, 124, 126 and 128, as well as the side illumination devices. As an example, illumination-effectuating unit 132 is configured here to output driving signals to illumination devices 122, 124, 126 and 128, as well as to the side illumination devices. The driving signals are capable of triggering the emission of electromagnetic radiation in the near infrared by illumination devices 122, 124, 126 and 128, as well as the side illumination devices. Thus, the first partial area, the second partial area, the third partial area and the fourth partial area of vehicle surroundings 101 are illuminated by illumination devices 122, 124, 126 and 128, as well as by the side illumination devices.

Read-in unit 134 of generating device 130 is configured to read in the image data from first vehicle camera 112, second vehicle camera 114, first side camera 116 and second side camera 118. The image data represent photos of the illuminated partial areas of vehicle surroundings 101.

Generating device 130 is also configured to combine the image data from first vehicle camera 112, second vehicle camera 114, first side camera 116 and second side camera 118, in order to generate the surround-view image of surroundings 101 of vehicle 100. Optionally, generating device 130 is also configured to make the generated surround-view image of surroundings 101 of vehicle 100 available to at least one driver-assistance system of vehicle 100, for example.

In other words, FIG. 1 shows a schematic top view of a vehicle 100 equipped with an NIR-based surround-view system. Four vehicle cameras 112, 114, 116 and 118 are shown illustratively, one in a front of the vehicle, one in a rear of the vehicle, and one in each of the side mirrors. Also shown are visual ranges of vehicle cameras 112, 114, 116 and 118, and active NIR-illumination devices 122, 124, 126 and 128 which are integrated respectively in front and rear lights of vehicle 100, as well as in flashers in exterior mirrors 102 and 104.

FIG. 2 shows a flowchart of a method 200 for generating a surround-view image of the surroundings of a vehicle according to one exemplary embodiment of the present invention. In this context, the vehicle has a first vehicle camera for photographing a first partial area of the vehicle surroundings and at least one second vehicle camera for photographing a second partial area of the vehicle surroundings differing at least in part from the first partial area of the surroundings. Method 200 may be carried out advantageously in conjunction with the device or generating device from FIG. 1. The device, i.e., the units of the device from FIG. 1, may be configured here to execute the steps of method 200.

Method 200 has a step 210 of effectuating illumination of the vehicle surroundings with the aid of at least two illumination devices. Using at least one first illumination device, the first partial area of the vehicle surroundings is illuminated by electromagnetic radiation in the visible range and/or in the infrared range. In addition, using at least one second illumination device, the second partial area of the vehicle surroundings is illuminated by electromagnetic radiation at least in the infrared range. In particular, in step 210 of effectuating the illumination, the electromagnetic radiation is radiated in the infrared range with a uniform spatial radiation characteristic. Moreover, in step 210 of effectuating the illumination, in particular, electromagnetic radiation in the near infrared is radiated. Method 200 also has a step 220 of reading in image data from the vehicle cameras, so as by combining the image data, to generate the surround-view image of the vehicle surroundings. In this context, the image data represent photos of the partial areas of the illuminated vehicle surroundings.

FIG. 3 shows a flowchart of a method 300 for providing at least one driver-assistance function for a vehicle using a surround-view image of the vehicle surroundings according to one exemplary embodiment of the present invention. Here, the vehicle has a first vehicle camera for photographing a first partial area of the vehicle surroundings and at least one second vehicle camera for photographing a second partial area of the vehicle surroundings differing at least in part from the first partial area of the surroundings. Thus, method 300 for providing at least one driver-assistance function may be carried out advantageously in conjunction with the device or generating device from FIG. 1. In addition, method 300 for providing may be carried out advantageously in conjunction with the method for generating a surround-view image from FIG. 2.

Method 300 has a step 310 of executing the steps of the method from FIG. 2 in order to generate the surround-view image of the vehicle surroundings. Thus, step 310 of the execution may have substeps of effectuating the illumination and of reading-in according to the method from FIG. 2. Method 300 also has a step 320 of evaluating the surround-view image generated, in order to provide the at least one driver-assistance function. The surround-view image is generated by executing the steps of the method from FIG. 2. In other words, prior to step 320 of the evaluation, method 300 also has the steps of the method from FIG. 2. In step 320 of the evaluation, the surround-view image generated is evaluated, e.g., with regard to obstacle areas and freely negotiable areas in the vehicle surroundings, in order to provide a parking-assistance function and/or a collision-warning function.

The exemplary embodiments described and illustrated in the figures are selected only by way of example. Different exemplary embodiments may be combined with each other completely or in terms of individual features. One exemplary embodiment may also be supplemented by features from another exemplary embodiment. Moreover, method steps may be repeated as well as executed in a sequence other than that described.

1-10. (canceled)

11. A method for generating a surround-view image of surroundings of a vehicle, the method comprising:
effectuating illumination of the vehicle surroundings with at least two illumination devices, where using at least one first illumination device, a first partial area of the vehicle surroundings is illuminated by electromagnetic radiation in the visible wavelength range and/or in the infrared wavelength range, and using at least one second illumination device, a second partial area of the vehicle surroundings is illuminated by electromagnetic radiation at least in the infrared wavelength range; and
reading in image data from vehicle cameras, the image data representing photos of the partial areas of the illuminated vehicle surroundings, so as by combining the image data, to generate the surround-view image of the surroundings of the vehicle;
wherein the vehicle has the vehicle cameras, which include a first vehicle camera for photographing the first partial area of the vehicle surroundings and at least one second vehicle camera for photographing the second partial area of the vehicle surroundings differing at least in part from the first partial area of the surroundings.

12. The method of claim 1, wherein in the effectuating of the illumination, wherein the electromagnetic radiation is radiated in the infrared wavelength range with a uniform spatial radiation characteristic.

13. The method of claim 1, wherein in the effectuating of the illumination, wherein electromagnetic radiation in the near infrared is radiated as the electromagnetic radiation in the infrared wavelength range.

14. A method for providing at least one driver-assistance function for a vehicle using a surround-view image of surroundings of the vehicle, the method comprising:
generating a surround-view image of surroundings of a vehicle, by performing the following:
effectuating illumination of the vehicle surroundings with at least two illumination devices, where using at least one first illumination device, a first partial area of the vehicle surroundings is illuminated by electromagnetic radiation in the visible wavelength range and/or in the infrared wavelength range, and using at least one second illumination device, a second partial area of the vehicle surroundings is illuminated by electromagnetic radiation at least in the infrared wavelength range; and
reading in image data from vehicle cameras, the image data representing photos of the partial areas of the illuminated vehicle surroundings, so as by combining the image data, to generate the surround-view image of the surroundings of the vehicle;
wherein the vehicle has the vehicle cameras, which include a first vehicle camera for photographing the first partial area of the vehicle surroundings and at least one second vehicle camera for photographing the second partial area of the vehicle surroundings differing at least in part from the first partial area of the surroundings; and
evaluating the surround-view image generated, in order to provide the at least one driver-assistance function.

15. The method of claim 4, wherein in the evaluating, the surround-view image generated is evaluated with regard to obstacle areas and freely negotiable areas in the vehicle surroundings, in order to provide a parking-assistance function and/or a collision-warning function.

16. A device for generating a surround-view image of surroundings of a vehicle, comprising:
an illuminating arrangement to effectuate illumination of the vehicle surroundings with at least two illumination devices, where using at least one first illumination device, a first partial area of the vehicle surroundings is illuminated by electromagnetic radiation in the visible wavelength range and/or in the infrared wavelength range, and using at least one second illumination device, a second partial area of the vehicle surroundings is illuminated by electromagnetic radiation at least in the infrared wavelength range; and
a reading in arrangement to read in image data from vehicle cameras, the image data representing photos of the partial areas of the illuminated vehicle surroundings, so as by combining the image data, to generate the surround-view image of the surroundings of the vehicle;
wherein the vehicle has the vehicle cameras, which include a first vehicle camera for photographing the first partial area of the vehicle surroundings and at least one second vehicle camera for photographing the second partial area of the vehicle surroundings differing at least in part from the first partial area of the surroundings.

17. A surround-view system for a vehicle, comprising:
a first vehicle camera for photographing a first partial area of a vehicle surroundings;
a second vehicle camera for photographing a second partial area of the vehicle surroundings differing at least in part from the first partial area of the surroundings;
at least one first illumination device for illuminating the first partial area of the vehicle surroundings with the aid of electromagnetic radiation in the visible wavelength range and/or in the infrared wavelength range;
at least one second illumination device for illuminating the second partial area of the vehicle surroundings with the electromagnetic radiation at least in the infrared wavelength range; and
a device for generating a surround-view image of surroundings of a vehicle, including:
an illuminating arrangement to effectuate illumination of the vehicle surroundings with the at least two illumination devices, where using the at least one first illumination device, the first partial area of the vehicle surroundings is illuminated by electromagnetic radiation in the visible wavelength range and/or in the infrared wavelength range, and using the at least one second illumination device, the second partial area of the vehicle surroundings is illuminated by electromagnetic radiation at least in the infrared wavelength range; and
a reading in arrangement to read in image data from vehicle cameras, the image data representing photos of the partial areas of the illuminated vehicle surroundings, so as by combining the image data, to generate the surround-view image of the surroundings of the vehicle;
wherein the vehicle has the vehicle cameras, which include the first vehicle camera for photographing the first partial area of the vehicle surroundings and the at least one second vehicle camera for photographing the second partial area of the vehicle surroundings differing at least in part from the first partial area of the surroundings.

18. The surround-view system of claim 17, wherein the first vehicle camera is positioned to photograph a partial area of the surroundings in the forward direction of travel of the vehicle as the first partial area of the vehicle surroundings, the second vehicle camera is positioned to photograph a partial area of the surroundings in the reverse direction of travel of the vehicle as the second partial area of the vehicle surroundings, the at least one first illumination device features a headlight of the vehicle or is disposed in the area of a headlight of the vehicle, and the at least one second illumination device is disposed in the area of a taillight of the vehicle.

19. The surround-view system of claim 17, further comprising:
a first vehicle side camera on a first exterior mirror of the vehicle for photographing a first sideward partial area of the vehicle surroundings between the first partial area and the second partial area of the surroundings;
a second vehicle side camera on a second exterior mirror of the vehicle for photographing a second sideward partial area of the vehicle surroundings that is between the first partial area and the second partial area of the surroundings and differs from the first sideward partial area of the surroundings;
a first side illumination device at the first exterior mirror for photographing the first sideward partial area of the surroundings with the aid of electromagnetic radiation in the infrared wavelength range; and
a second side illumination device at the second exterior mirror for photographing the second sideward partial area of the surroundings with the aid of electromagnetic radiation in the infrared wavelength range.

20. A computer readable medium having a computer program, which is executable by a processor, comprising:
a program code arrangement having program code for generating a surround-view image of surroundings of a vehicle, by performing the following:
effectuating illumination of the vehicle surroundings with at least two illumination devices, where using at least one first illumination device, a first partial area of the vehicle surroundings is illuminated by electromagnetic radiation in the visible wavelength range and/or in the infrared wavelength range, and using at least one second illumination device, a second partial area of the vehicle surroundings is illuminated by electromagnetic radiation at least in the infrared wavelength range; and
p1 reading in image data from vehicle cameras, the image data representing photos of the partial areas of the illuminated vehicle surroundings, so as by combining the image data, to generate the surround-view image of the surroundings of the vehicle;
wherein the vehicle has the vehicle cameras, which include a first vehicle camera for photographing the first partial area of the vehicle surroundings and at least one second vehicle camera for photographing the second partial area of the vehicle surroundings differing at least in part from the first partial area of the surroundings.
